(19) United States
(12) Patent Application Publication
(10) Pub. No.: US 2012/0154977 A1
(43) Pub. Date: Jun. 21, 2012

(54) CONDUCTIVE PASTE COMPOSITION FOR TERMINATION ELECTRODE, MULTILAYER CERAMIC CAPACITOR INCLUDING THE SAME AND METHOD OF MANUFACTURING THEREOF

(75) Inventors: Kang Heon HUR, Seongnam (KR); Chang Hoon KIM, Yongin (KR); Sung Bum SOHN, Seongnam (KR); Ji Sook KIM, Seoul (KR); Hyun Hee GU, Yongin (KR); Gun Jung YOON, Seoul (KR); Kyu Ha LEE, Suwon (KR); Sang Hoon KWON, Suwon (KR); Myung Jun PARK, Cheongju (KR)

(73) Assignee: SAMSUNG ELECTRO-MECHANICS CO., LTD.

(21) Appl. No.: 13/111,319

(22) Filed: May 19, 2011

(30) Foreign Application Priority Data
Dec. 17, 2010 (KR) 10-2010-0130318

(51) Int. Cl. H01G 4/008; B32B 38/10; B32B 37/06; B32B 37/14; H01B 1/16; B32B 37/02

(52) U.S. Cl. 361/303; 252/512; 156/89.16; 156/89.18

(57) ABSTRACT

There are provided a conductive paste composition for a termination electrode, a multilayer ceramic capacitor having the same, and a method thereof. The conductive paste composition for a termination electrode includes a conductive metal powder and a glass frit represented by the following Formula: aSiO₂-bB₂O₃-cAl₂O₃-dTMₓO_{y}-eR¹₂O-fR²O, where TM is a transition metal selected from a group consisting of zinc (Zn), titanium (Ti), copper (Cu), vanadium (V), manganese (Mn), iron (Fe) and nickel (Ni); R¹ is selected from a group consisting of lithium (Li), sodium (Na) and potassium (K); R² is selected from a group consisting of magnesium (Mg), calcium (Ca), strontium (Sr) and barium (Ba); each of x and y is larger than 0; and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %. The conductive paste composition for a termination electrode includes a glass frit compound having improved corrosion resistance to a plating solution, thus effectively preventing the penetration of the plating solution and enhancing chip reliability.

### CROSS-REFERENCE TO RELATED APPLICATIONS

This application claims the priority of Korean Patent Application No. 10-2010-0130318 filed on Dec. 17, 2010, in the Korean Intellectual Property Office, the disclosure of which is incorporated herein by reference.

### BACKGROUND OF THE INVENTION

1. Field of the Invention

The present invention relates to a conductive paste composition for a termination electrode capable of improving chip reliability, a multilayer ceramic capacitor comprising the same, and a manufacturing method thereof.

2. Description of the Related Art

An electronic component fabricated using a ceramic material, such as a capacitor, an inductor, a piezoelectric device, a varistor, a thermistor, or the like, generally has a ceramic body made of a ceramic material, internal electrodes provided in the ceramic body, and external electrodes (that is, termination electrodes) placed on a surface of the ceramic body and electrically connected to the internal electrodes.

Among ceramic electronic components, a multilayer ceramic capacitor typically includes a plurality of sequentially laminated dielectric layers, internal electrodes arranged to face each other while having each dielectric layer disposed therebetween, and termination electrodes electrically connected to respective internal electrodes.

Such a multilayer ceramic capacitor has beneficial features such as a small size but a high capacity, simple mounting, and the like, thereby being widely used in mobile communications equipment such as computers, PDAs, mobile phones, and so forth.

In recent years, with the trend towards production of smaller sized multi-functional electronic products, chip parts are also becoming smaller and tend to be high performance. In response, high capacity multilayer ceramic capacitors having a large capacity while having a small size are required.

In this regard, an attempt to allow the multilayer ceramic capacitor to be miniaturized and to have a large capacity by reducing the thickness of a termination electrode layer, while maintaining an overall chip size thereof, has been carried out.

However, when the termination electrode layer become thin, a degree of electrode compactness or the coverage of an electrode decreases, and in such a case, a plating solution may tend to be penetrated into the termination electrode during plating, after the calcination of the termination electrode.

If a glass ingredient in the termination electrode does not have high corrosion resistance to ingredients within the plating solution, the glass ingredient may be eroded and the plating solution may be penetrated into a chip through the termination electrode, thus causing a deterioration in chip reliability.

### SUMMARY OF THE INVENTION

An aspect of the present invention is to provide a conductive paste composition for a termination electrode capable of improving chip reliability, a multilayer ceramic capacitor having the same, and a manufacturing method thereof.

According to an exemplary embodiment of the present invention, there is provided a conductive paste composition for a termination electrode, comprising a conductive metal powder; and a glass frit represented by the following Formula: aSiO₂-bB₂O₃-cAl₂O₃-dTMₓO_{y}-eR¹₂O-fR²O, where TM is a transition metal selected from a group consisting of zinc (Zn), titanium (Ti), copper (Cu), vanadium (V), manganese (Mn), iron (Fe) and nickel (Ni); R¹ is selected from a group consisting of lithium (Li), sodium (Na) and potassium (K); R² is selected from a group consisting of magnesium (Mg), calcium (Ca), strontium (Sr) and barium (Ba); each of x and y is larger than 0; and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %, provided that these factors are selected respectively in such a manner that a+b+c+d+e+f=100 mole percent (mol %).

The conductive metal powder may be Cu.

The glass frit may have an average particle size ranging from 3.0 to 4.0 μm.

A content of the glass frit ranges from 5 to 20 parts by weight (wt %) relative to 100 wt % of the conductive metal powder.

Another exemplary embodiment of the present invention provides a method of manufacturing a conductive paste composition for a termination electrode, the method comprising: weighing each of a silicon oxide, a boron oxide, an aluminum oxide, a transition metal oxide, an alkali-metal oxide and an alkali-earth metal oxide and melting these oxides; cooling the molten solution to prepare glass flakes; milling the glass flakes to form a glass frit; and mixing the glass frit with a conductive metal powder to prepare a paste.

The transition metal may be at least one selected from Zn, Ti, Cu, V, Mn, Fe and Ni.

The alkali metal may be at least one selected from a group consisting of Li, Na and K.

The alkali-earth metal may be at least one selected from Mg, Ca, Sr and Ba.

The melting may be carried out at 1400° C. by heating the oxides at a heating rate of 10° C./min.

The milling may be wet milling using alcohol.

According to another exemplary embodiment of the present invention, there is provided a multilayer ceramic capacitor comprising: a ceramic body; internal electrode layers provided in the ceramic body, one ends of which are alternately exposed to end surfaces of the ceramic body; and termination electrodes formed on the end surfaces of the ceramic body and electrically connected to the internal electrode layers, wherein the termination electrodes are fabricated by calcination of a conductive paste composition which includes a conductive metal powder and a glass frit represented by the following Formula: aSiO₂-bB₂O₃-cAl₂O₃-dTMₓO_{y}-eR¹₂O-fR²O, where TM is a transition metal selected from a group consisting of Zn, Ti, Cu, V, Mn, Fe and Ni, R¹ is selected from a group consisting of Li, Na and K, R² is selected from a group consisting of Mg, Ca, Sr and Ba, each of x and y is larger than 0, and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %, provided that these factors are selected respectively in such a manner that a+b+c+d+e+f=100 mol %.

Another exemplary embodiment of the present invention provides a method of manufacturing a multilayer ceramic capacitor, comprising: preparing a plurality of ceramic green sheets; forming internal electrode patterns on the ceramic green sheets; stacking the ceramic green sheets having the internal electrode patterns formed thereon, in order to form a ceramic laminate; cutting the ceramic laminate to allow one ends of the internal electrode patterns to be alternately exposed through the cut sides of the ceramic laminate, and then, calcining the cut ceramic laminate to produce a ceramic body; forming termination electrode patterns by using a conductive paste composition for a termination electrode, on end surfaces of the ceramic body in such a manner that the termination electrode patterns are electrically connected to the one ends of the internal electrode patterns, the conductive paste composition comprising a conductive metal powder and a glass frit represented by the following Formula: aSiO₂-bB₂O₃-cAl₂O₃-dTMₓO_{y}-eR¹₂O-fR²O, where TM is a transition metal selected from a group consisting of Zn, Ti, Cu, V, Mn, Fe and Ni, R¹ is selected from a group consisting of Li, Na and K, R² is selected from a group consisting of Mg, Ca, Sr and Ba, each of x and y is larger than 0, and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %, provided that these factors are selected respectively in such a manner that a+b+c+d+e+f=100 mol %; and sintering the termination electrode patterns to form termination electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a multilayer ceramic capacitor according to an exemplary embodiment of the present invention;

FIG. 2 is a cross-sectional view taken along line A-A′ shown in FIG. 1;

FIG. 3 is a flowchart illustrating a process of manufacturing a multilayer ceramic capacitor according to an exemplary embodiment of the present invention;

FIG. 4 is electron micrographs comparing a surface and a cross section of a termination electrode according to an example of the present invention with the surfaces and the cross sections of termination electrodes according to comparative examples; and

FIGS. 5A and 5b are electron micrographs comparing a cross section of an electrode-calcined chip according to an example of the present invention with a cross section of an electrode-calcined chip according to an comparative example, after polishing the cross sections of the chips and submerging the same in a tin (Sn) plating solution for 1 hour.

### DETAILED DESCRIPTION OF THE PREFERRED EMBODIMENT

Hereinafter, preferred embodiments of the present invention will be described in detail with reference to the accompanying drawings.

However, the present invention may be embodied in different forms and should not be construed as limited to the embodiments set forth herein. Rather, these embodiments are provided so that this disclosure will be thorough and complete, and will fully convey the scope of the present invention to those skilled in the art to which the present invention pertains.

Therefore, shapes and/or sizes of respective elements shown in the accompanying drawings may be enlarged for clarity and like reference numerals denote elements substantially having the same configurations or performing similar functions and actions throughout the drawings.

A conductive paste composition for a termination electrode according to an exemplary embodiment of the present invention includes: a conductive metal powder and a glass frit represented by the following Formula: aSiO₂-bB₂O₃-cAl₂O₃-dTMₓO_{y}-eR¹₂O-fR²O, where TM is a transition metal selected from the group consisting of zinc (Zn), titanium (Ti), copper(Cu), vanadium (V), manganese (Mn), iron (Fe) and nickel (Ni), R¹ is selected from a group consisting of lithium (Li), natrium (Na) and potassium(K), R² is selected from the group consisting of magnesium (Mg), calcium (Ca), strontium (Sr) and barium (Ba), each of x and y is larger than 0, and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %, provided that these factors are selected respectively in such a manner that a+b+c+d+e+f=100 mole percent (mol %).

The conductive metal powder is not particularly limited so long as it is used for fabricating a termination electrode and may include, for example, Cu or the like.

The content of the conductive metal powder to prepare the conductive paste composition for a termination electrode may be varied according to exemplary embodiments of the present invention without particularly limitation thereof.

As a thickness of the termination electrode is reduced in order to reduce a size of a multilayer ceramic capacitor and increase capacity thereof, a plating solution easily penetrates into the electrode during plating after calcination of the termination electrode, thus causing defects of worse chip reliability.

In such case, since a glass within the termination electrode does not have superior corrosion resistance to the plating solution, the glass is eroded by the plating solution, which causes the penetration of the plating solution into the electrode.

Accordingly, in order to solve the defects such as penetration of a plating solution into an electrode and deterioration in chip reliability caused by the penetration, according to an exemplary embodiment of the present invention, a conductive paste composition containing a glass frit having excellent corrosion resistance to a plating solution is provided.

That is, by improving the corrosion resistance of a glass in a termination electrode to a plating solution, the penetration of the plating solution into the electrode during plating may be prevented, thus enhancing chip reliability.

Glass used for the termination electrode comprises a mixture of various oxides and, according to an exemplary embodiment of the present invention, in order to improve corrosion resistance of the glass to the plating solution, types or contents of the foregoing oxides may be adjusted.

That is, according to an exemplary embodiment of the present invention, the corrosion resistance of the glass to the plating solution may be enhanced by increasing the ratio of a glass network former such as a silicon oxide (SiO₂) and a boron oxide (B₂O₃).

More particularly, according to an exemplary embodiment of the present invention, a glass frit contained in a conductive paste composition for a termination electrode, may have a composition represented by the following Formula: aSiO₂-bB₂O₃-cAl₂O₃-dTMₓO_{y}-eR¹₂O-fR²O.

Herein, a mole percent ‘a’ of the silicon oxide (SiO₂) may be variously defined in order to improve corrosion resistance to the plating solution, however, it may range from 15 to 70 mol %.

If this ‘a’ is less than 15 mol %, the corrosion resistance to the plating solution is insignificant and, when it exceeds 70 mol %, SiO₂ shows poor wettability to Cu (referred to as ‘Cu wettability’). Therefore, the forgoing range may be preferable.

B₂O₃ is also a glass network former, and a mole percent ‘b’ of the boron oxide (B₂O₃) may be variously defined in order to improve the corrosion resistance to the plating solution, and ‘b’ may range from 15 to 45 mol %.

If this ‘b’ is less than 15 mol %, the corrosion resistance to the plating solution is insignificant and, when it exceeds 45 mol %, B₂O₃ shows poor wettability to Cu.

Likewise, a mole percent ‘c’ of the aluminum oxide (Al₂O₃) contained in the composition of the glass frit may be variously defined and, may range from 1 to 10 mol %.

The composition of the glass frit may also include a transition metal oxide (TMₓO_{y}), and here, a transition metal used herein is not particularly limited and may include, for example, Zn, Ti, Cu, V, Mn, Fe, Ni, and the like, which may be used alone or in combination of two or more thereof.

x and y are positive numbers and may be defined as various numbers depending upon types of the transition metal oxide.

A mole percent ‘d’ of the transition metal oxide (TMₓO_{y}) may be variously defined according to aspects of the present invention, and may range from 1 to 50 mol %.

The glass frit may further include an additional oxide represented by R¹₂O and R²O.

Here, R¹ is any one of alkali metals without being particularly limited thereto and may include, for example, Li, Na, K, and the like, which may be used alone or in combination of two or more thereof.

Further, a mole percent ‘e’ of the oxide (R¹₂O) may be variously defined according to aspects of the present invention, and may range from 2 to 30 mol %.

R² is any on of alkali-earth metals without being particularly limited thereto and may include, for example, Mg, Ca, Sr, Ba, and the like, which may be used alone or in combination of two or more thereof.

In addition, a mole percent ‘f’ of the oxide (R²O) may be variously defined according to aspects of the present invention, and may range from 5 to 40 mol %.

As described above, the paste composition according to an exemplary embodiment of the present invention includes a glass frit having relatively high contents of silicon oxide and boron oxide, the glass network formers, in order to increase corrosion resistance to a plating solution, thereby enhancing chip reliability.

An average particle size of the glass frit may be variously defined according to exemplary embodiments of the present invention and, may range from 3.0 to 4.0 μm.

The average particle size of the glass frit may be suitably controlled in order to simultaneously secure excellent wettability to the conductive metal powder, especially, Cu, as well as enhanced corrosion resistance to a plating solution.

Moreover, the content of the glass frit may be variously defined according to aspects of the present invention and may range from 5 to 20 parts by weight (wt %) relative to 100 wt % of the conductive metal powder.

When the content of the glass frit is less than 5 wt %, it is insufficient to attain an improvement in chip reliability by preventing the penetration of the plating solution. On the other hand, when the content of the glass frit exceeds 20 wt %, a defect of phase separation may be caused during a glass melting process.

A method of manufacturing a conductive paste composition for a termination electrode according to an exemplary embodiment of the present invention includes: weighing each of a silicon oxide, a boron oxide, an aluminum oxide, a transition metal oxide, an alkali-metal oxide and an alkali-earth metal oxide and melting these oxides; cooling the molten solution to prepare glass flakes; milling the glass flakes to form a glass frit; and blending the glass frit with a conductive metal powder to prepare a paste.

The following detailed description will be given to explain respective processes of the method of manufacturing a conductive paste composition for a termination electrode.

First, each of a silicon oxide, a boron oxide, an aluminum oxide, a transition metal oxide, an alkali metal oxide and an alkali-earth metal oxide are weighed, and the weighed oxides are molten.

The weighing of each of oxides is conducted based on the composition of the glass frit contained in the conductive paste composition for a termination electrode according to the foregoing exemplary embodiment of the present invention.

The types of transition metal, alkali metal and alkali-earth metal are the same as in the composition of the glass frit as described above.

The melting may be conducted at 1400° C. by heating the weighed oxides at a heating rate of 10° C./min.

Then, the molten solution is subjected to cooling to prepare glass flakes and the cooling process may be carried out using a twin roller.

Following this, milling of the glass flakes may be performed in order to obtain a glass frit. The milling may be conducted to control an average particle size of the glass frit by milling methods without particular limitation and, for example, the milling is performed by dry and wet processes.

Such dry and wet milling processes may be performed to control the average particle size of the glass frit in the range of 3.0 to 4.0 μm.

The wet milling process may be carried out using alcohol.

Lastly, the glass frit is mixed with the conductive metal powder to prepare a paste and the paste may further include a base resin, an organic vehicle and other additives.

The conductive metal powder may be Cu, as described above, and the content thereof may be various depending on aspects of the present invention.

The content of the glass frit may be variously defined according to aspects of the present invention. For instance, the content of the glass frit may range from 5 to 20 wt % relative to 100 wt % of the conductive metal powder.

The base resin, the organic vehicle and the other additives are not particularly limited so long as they are generally used in manufacturing a conductive paste composition for a termination electrode, and contents thereof may also be desirably varied according to aspects of the present invention.

The conductive paste composition for a termination electrode manufactured by the manufacturing method according to the foregoing exemplary embodiment of the present invention may contain the glass frit having improved corrosion resistance to the plating solution.

Therefore, by inhibiting the penetration of the plating solution into an internal electrode layer during plating, chip reliability may be enhanced even in the case of manufacturing a multilayer ceramic capacitor having an ultra-compact size and high capacity.

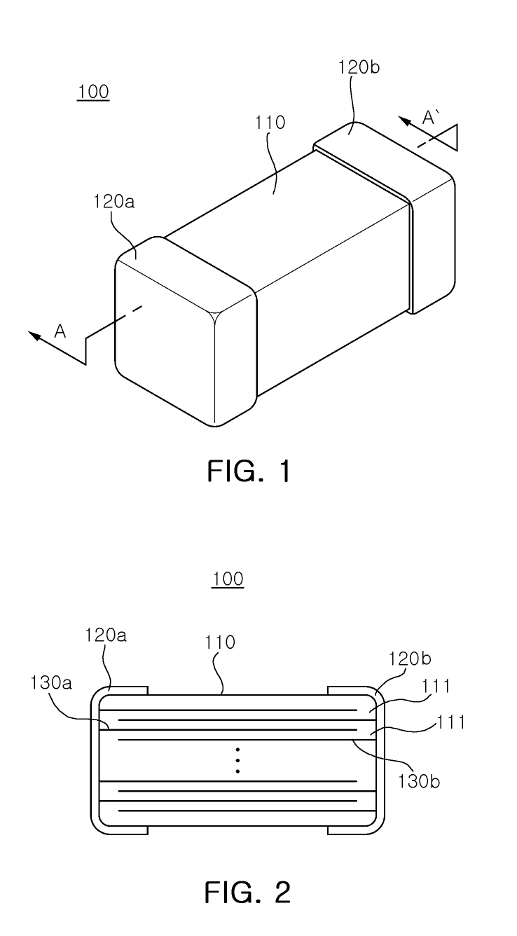

FIG. 1 is a perspective view illustrating a multilayer ceramic capacitor according to an exemplary embodiment of the present invention, and FIG. 2 is a cross-sectional view taken along line A-A′ shown in FIG. 1.

Referring to FIGS. 1 and 2, a multilayer ceramic capacitor 100 according to this exemplary embodiment of the present invention includes: a ceramic body 110; internal electrode layers 130a and 130b formed in the ceramic body 110; and external electrodes (that is, termination electrodes) 120a and 120b electrically connected to the internal electrodes.

The ceramic body 110 is fabricated by stacking a plurality of ceramic dielectric layers 111, and then, sintering the same. Accordingly, adjacent dielectric layers are substantially integrated to a degree in which a boundary therebetween may not be readily apparent.

The ceramic dielectric layers 111 may be made of a ceramic material having a high dielectric constant, however, not being particularly limited thereto. For instance, a barium titanate (BaTiO₃) based material, a lead-complex perovskite based material and/or a strontium titanate (SrTiO₃) based material may be used.

The internal electrode layers 130a and 130b are provided at opposite sides of each dielectric layer during the stacking of the plurality of dielectric layers. More particularly, the internal electrode layers 130a and 130b are formed in the ceramic body through sintering, while having each dielectric layer disposed therebetween.

The internal electrode layers 130a and 130b may be provided as pairs of electrodes, each having an opposite polarity, and arranged opposite to each other based on the stacking direction of the dielectric layer, and electrically isolated from each other by the dielectric layer.

One ends of the internal electrode layers 130a and 130b are alternately exposed to both end surfaces of the ceramic body. The one ends of the internal electrode layers 130a and 130b exposed to the end surfaces of the ceramic body are electrically connected to the termination electrodes 120a and 120b, respectively.

When a predetermined voltage is applied to the termination electrodes 120a and 120b, charge is accumulated between the internal electrode layers 130a and 130b arranged opposed to each other and the static capacity of the multilayer ceramic capacitor may be proportional to an area of the internal electrode layers 130a and 130b.

The internal electrode layers 130a and 130b may be formed of any conductive metal without particular limitation thereof and, the conductive metal may include, for example, Ag, Pb, Pt, Ni Cu, and the like, which may be used alone or in combination of two or more thereof.

The termination electrodes 120a and 120b may be fabricated by calcination of the conductive paste for a termination electrode according to the exemplary embodiment of the present invention, and the composition and the content of the paste have been described above.

A multilayer ceramic capacitor according to an exemplary embodiment of the present invention has a termination electrode formed of a paste composition containing a glass frit having improved corrosion resistance to a plating solution, as described above. Therefore, it is possible to prevent the penetration of the plating solution into the internal electrode of the capacitor, thereby allowing for excellent chip reliability of the capacitor.

Because of the foregoing effects, a multilayer ceramic capacitor having an ultra-compact size and an extremely high capacity may be fabricated according to an exemplary embodiment of the present invention.

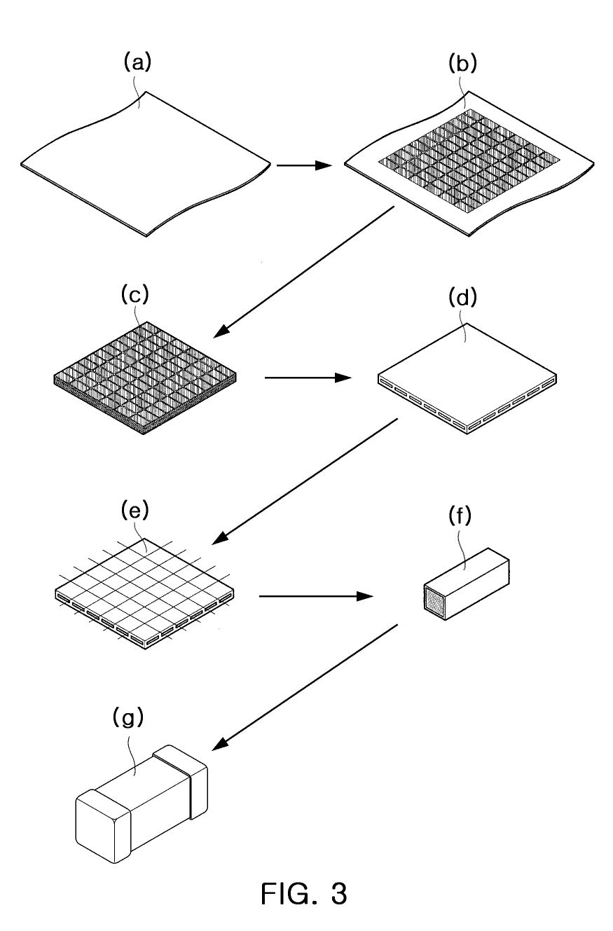

FIG. 3 is a flowchart illustrating a process of manufacturing a multilayer ceramic capacitor according to an exemplary embodiment of the present invention.

Referring to FIG. 3, the process of manufacturing a multilayer ceramic capacitor according to the exemplary embodiment of the present invention includes: preparing a plurality of ceramic green sheets; forming internal electrode patterns on the ceramic green sheets; stacking the ceramic green sheets having the internal electrode patterns formed thereon, to form a ceramic laminate; cutting the ceramic laminate to allow the one ends of the internal electrode patterns to be alternately exposed through the cut sides of the ceramic laminate and then, calcining the same to produce a ceramic body; forming termination electrode patterns such that these patterns are electrically connected to the exposed ends of the internal electrode patterns; and sintering the termination electrode patterns, thereby forming termination electrodes.

The following detailed description will be given to explain respective processes of the method of manufacturing a multilayer ceramic capacitor according to the foregoing exemplary embodiment.

(a) First, a plurality of ceramic green sheets may be prepared. Each of the ceramic green sheets is prepared in the form of a sheet having a thickness of several micrometers (μm) by mixing a ceramic powder, a binder, and a solvent to prepare a slurry, and using the slurry through a doctor blade method.

(b) Then, internal electrode patterns are formed by applying an internal electrode paste to surfaces of the prepared ceramic green sheets.

Such internal electrode patterns may be formed by screen printing.

The internal electrode paste used herein is any metal powder without being particularly limited thereto, and may be prepared by dispersing powder made of Ni or Ni alloy in an organic binder and an organic solvent to produce a paste type product.

The organic binder used herein is any binder well known in the art without being particularly limited thereto, however, may include, for example, cellulose resin, epoxy resin, aryl resin, acryl resin, phenol-formaldehyde resin, unsaturated polyester resin, polycarbonate resin, polyamide resin, polyimide resin, alkyd resin, rosin ester, or the like.

Also, the organic solvent used herein may be any solvent well known in the art without being particularly limited thereto, however, may include, for example, butyl carbitol, butyl carbitol acetate, turpentine, terebineol, butyl phthalate, and the like.

(c) Next, the plurality of ceramic green sheets having the internal electrode patterns formed thereon are stacked and pressurized to allow the ceramic green sheets to be compressed with the internal electrode paste.

(d) Therefore, a ceramic laminate having the plurality of ceramic green sheets and the internal electrode paste alternately stacked with one another may be fabricated.

(e) Following this, the formed ceramic laminate is cut into pieces, each of which corresponds to one capacitor.

The cutting is carried out such that the one ends of the internal electrode patterns are alternately exposed through the cut sides of the ceramic laminate.

(f) After this, the cut laminate pieces are subjected to calcination, for example, at 1200° C. to thereby fabricate a ceramic body.

The ceramic body is subjected to treatment in a barrel containing water and a polishing medium, to thereby conduct surface polishing.

The surface polishing may be performed during the fabrication of the ceramic laminate.

(g) Next, termination electrodes are fabricated in such a manner as to be electrically connected to the internal electrodes exposed to end surfaces of the ceramic body.

The following description will be given to concretely explain a method of fabricating termination electrodes.

More particularly, termination electrode patterns are formed by applying the conductive paste for a termination electrode according to the foregoing exemplary embodiment of the present invention to end surfaces of the ceramic body.

Through sintering the conductive paste for a termination electrode, termination electrodes may be fabricated.

The sintering of the conductive paste for a termination electrode may be conducted at 600 to 900° C.

After this, surfaces of the termination electrodes may be subjected to plating treatment using Ni, Sn, and so forth.

In recent years, with a tendency towards the production of multilayer ceramic capacitors having an ultra-compact size and a high capacity, the thickness of a termination electrode has been reduced. This causes a defect in that a plating solution penetrates into an internal electrode layer during plating.

According to an exemplary embodiment of the present invention, a termination electrode may be fabricated by using a conductive paste which includes a glass frit composition having enhanced corrosion resistance to a plating solution, thereby preventing the penetration of the plating solution into an internal electrode layer.

Consequently, according to a method of manufacturing a multilayer ceramic capacitor according to an exemplary embodiment of the present invention, a multilayer ceramic capacitor having an improvement in reliability of the capacitor while having an ultra-compact size and a high capacity.

Hereinafter, the present invention will be described in detail with reference to the following inventive example and comparative examples; however, the scope of the present invention is not limited thereto.

### Example 1

In the example 1, after weighing respective components of a composition represented by the following Formula: aSiO₂-bB₂O₃-cAl₂O₃-dTMₓO_{y}-eR¹₂O-fR²O and melting the same at 1400° C. at a heating rate of 10° C./min, the molten solution was rapidly cooled using a twin roller to form glass flakes. Then, the glass flakes were subjected to a dry milling process and a wet milling process using alcohol, to obtain a glass frit having an average particle size of 3.5 μm.

In the composition of the glass frit, the types and concrete contents of the transition metal (TM), and R¹ and R² are shown in Table 1.

### COMPARATIVE EXAMPLES 1 TO 10

In each of these comparative examples 1 to 10, a glass frit was prepared by the same procedures as described in example 1 except that types and contents of respective oxides contained in a glass frit composition represented by the following Formula: aSiO₂-bB₂O₃-cAl₂O₃-dTMₓO_{y}-eR¹₂O-fR²O were beyond the range defined by the present invention.

In addition, particular types and contents of oxides used herein are shown in Table 1.

The physical properties of a glass were assessed by measuring the degree of glass formation therein, the softening temperature thereof, level of corrosion resistance to Sn plating solution thereof, and whether or not glass elution remains on the surface of a termination electrode during the application/calcination of a paste after the fabrication thereof.

As for the degree of glass formation, the glass was determined as ‘NG(no good)’ if the glass was incompletely molten during a glass melting process or the molten glass was unstable due to phase separation occurring therein.

The softening temperature was measured by using TG/DTA and a high temperature microscope at a heating rate of 10° C./min.

The corrosion resistance to Sn plating solution was assessed as follows. After melting a glass and then cooling the same, cullets are obtained. The obtained cullets are immersed in the Sn plating solution at 60° C. for 1 hour, and then a weight loss of the glass due to glass elution is measured. In this case, after measuring an actual weight loss of the glass prepared in each of Example 1 and Comparative Examples 1 to 10, the measured weight loss of each glass was calculated in terms of ‘100’ that indicates the largest weight loss of the glass in Comparative Example 1. When the calculated weight loss was not more than 10, the glass having such weight loss was determined to be acceptable.

After assessing the physical properties of the glass, a paste containing the glass frit prepared in the Example 1 was applied to a chip which had been subjected to calcination, the chip subsequently being subjected to electrode calcination at 785° C. The surface of the chip after the electrode calcination was subjected to a scanning electron microscope (SEM) analysis.

Based on analysis results, when an area of the glass covering the surface of the electrode has a width of 10 μm or more, the glass is determined to be NG.

Moreover, after polishing the cross section of the chip, the polished chip was submerged in the Sn plating solution. Then, the chip was observed through SEM in order to determine whether or not a glass portion in a termination electrode of the chip was eroded.

TABLE 1

| | | | Exam- | Com. | Com. | Com. | Com. | Com. | Com. | Com. | Com. | Com. | Com. |
|---|---|---|---|---|---|---|---|---|---|---|---|---|---|
| | | | ple | Ex. 1 | Ex. 2 | Ex. 3 | Ex. 4 | Ex. 5 | Ex. 6 | Ex. 7 | Ex. 8 | Ex. 9 | Ex. 10 |
| Constitutional | SiO₂ | | 44 | 7 | 65 | 20 | 22 | 12 | 51 | 7 | 52 | 35 | 50 |
| composition | B₂O₃ | | 20 | 24 | 20 | 35 | 24 | 34 | 19 | 14 | 19 | 35 | 18 |
| of glass | Al₂O₃ | | 1 | 4 | 0 | 0 | 4 | 4 | 0 | 4 | 0 | 5 | 0 |
| | TM_{X}O_{Y} | ZnO | 3 | 28 | 0 | 5 | 13 | 13 | 0 | 28 | | 15 | |
| | | TiO₂ | | | | 5 | | | | | | | |
| | | V₂O₅ | 6 | | | | | | 7 | | | | 10 |
| | | CuO | | | | | | | | | 5 | | |
| | RO | Li₂O | 12 | 0 | 10 | 10 | 0 | 0 | 16 | 0 | 17 | 0 | 15 |
| | | K₂O | 5 | | 5 | 5 | | | 7 | | 7 | | 7 |
| | RO | BaO | 7 | 28 | 0 | 10 | 28 | 28 | 0 | 38 | 0 | 5 | 0 |
| | | CaO | 2 | 9 | | 10 | 9 | 9 | | 9 | | 5 | |

| | | | | | | | | | | | | |
|---|---|---|---|---|---|---|---|---|---|---|---|---|
| | sum | 100 | 100 | 100 | 100 | 100 | 100 | 100 | 100 | 100 | 100 | 100 |
| Physical | Formation of glass | ∘ | ∘ | ∘ | ∘ | ∘ | ∘ | ∘ | x | ∘ | x | x |
| properties | Softening temperature(° C.) | 585 | 625 | 666 | 607 | 696 | 666 | 536 | — | 571 | — | — |
| to be assessed | Corrosion resistance | 4.2 | 100 | 0 | 50.6 | 37.6 | 76.8 | 1.3 | — | 10.7 | — | — |
| | to Sn plating solution (%) | | | | | | | | | | | |
| | Actual weight loss (%) | 0.6 | 14.8 | 0.0 | 7.5 | 5.6 | 11.4 | 0.2 | — | 1.6 | — | — |
| | Glass elution | Accept- | Accept- | NG | NG | Accept- | NG | NG | — | NG | — | — |
| | | able | able | | | able | | | | | | |

| | | | | | | | | | | | |
|---|---|---|---|---|---|---|---|---|---|---|---|
| results | ∘ | x | x | x | x | x | x | x | x | x | x |

[Unit of constitutional composition: mole percent (mol %)]

As for the inventive example, that is, Example 1, the glass frit had a constitutional composition satisfying the range defined by the appended claims and the corrosion resistance of the glass frit to the plating solution was about 4.2%, which is relatively good, compared to Comparative Example 1. In addition, this glass frit did not exhibit glass elution after electrode calcination, therefore, was determined to be suitable for a paste for a termination electrode.

As for Comparative Example 1, an amount of TMₓO_{y} was about 28 mol % and the glass frit exhibited favorable Ni—Cu contact properties and excellent wettability to Cu. However, an amount of SiO₂ was 7 mol % which is beyond the range of 15 to 70 mol % defined by the appended claims of the present invention. Therefore, the glass frit prepared in Comparative Example 1 had very worse corrosion resistance to Sn plating solution.

As for Comparative Example 2, the glass frit did not include Al₂O₃, TMₓO_{y} and R²O and showed significant glass elution on an electrode after calcination thereof, although it had excellent corrosion resistance to a plating solution.

As for Comparative Example 3, the glass frit free of Al₂O₃ exhibited a relatively lower corrosion resistance to a plating of 50.6%, compared to Comparative Example 1, and significant glass elution on an electrode after calcination thereof.

As for Comparative Example 4, the glass frit free of R¹₂O exhibited a relatively lower corrosion resistance to a plating of 37.6%, compared to Comparative Example 1, however, was acceptable in respect to glass elution on an electrode after calcination thereof.

As for Comparative Example 5, the glass frit contained 12 mol % of SiO₂, which is beyond the range defined by the appended claims of the present invention, and did not include R¹₂O. As a result, this glass frit had poor corrosion resistance to a plating solution of 76.8%, compared to Comparative Example 1, and exhibited significant glass elution on an electrode after calcination thereof.

As for Comparative Example 6, the glass frit did not include Al₂O₃, TMₓO_{y} and R²O and showed significant glass elution on an electrode after calcination thereof, although having good corrosion resistance to a plating solution of 1.3% compared to Comparative Example 1.

As for Comparative Example 7, the glass frit contained 7 mol % of SiO₂, 14 mol % of B₂O₃ and 47 mol % of R²O, all of which are beyond the ranges defined by the appended claims of the present invention, and did not contain R¹₂O. As a result, this glass frit was unstable during a glass melting process and showed phase separation, therefore, not being subjected to a further assessment.

As for Comparative Example 8, the glass frit did not include Al₂O₃ and R²O and showed a lower corrosion resistance to a plating solution of 10.7%, compared to Comparative Example 1, and significant glass elution on an electrode after calcination thereof.

As for Comparative Example 9, the glass frit did not include R¹₂O and showed incomplete melting of the glass during a glass melting process, thus not being subjected to a further assessment.

As for Comparative Example 10, the glass frit did not include Al₂O₃ and R²O and was unstable during a glass melting process and showed phase separation, thus not being subjected to a further assessment.

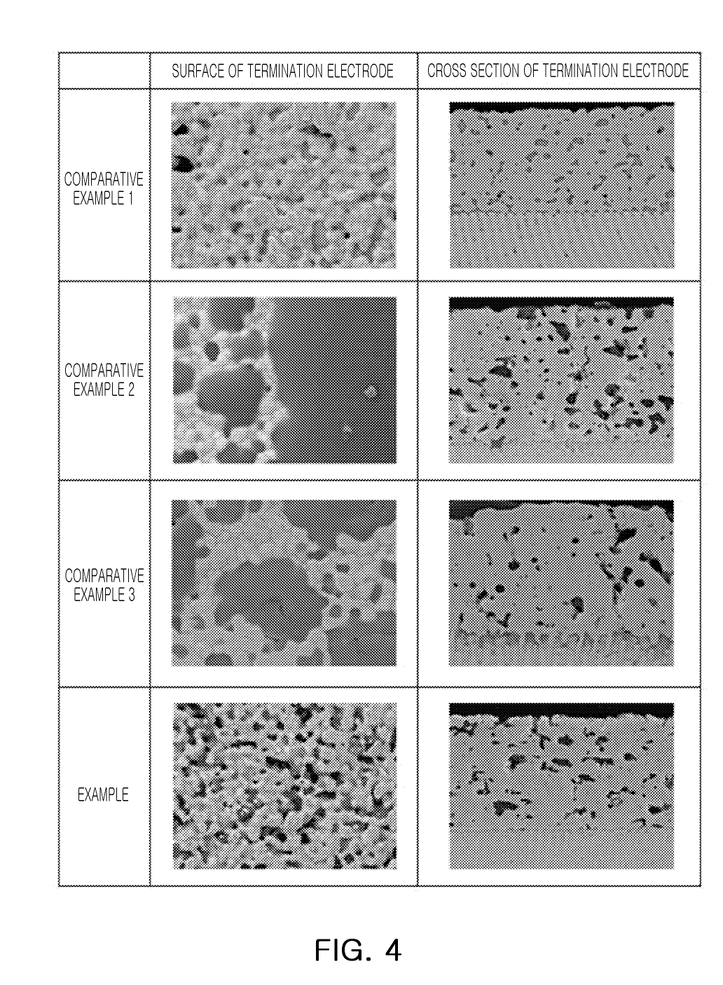

FIG. 4 is electron micrographs comparing a surface and a cross section of a termination electrode according to an example of the present invention with the surfaces and the cross sections of termination electrodes according to comparative Examples.

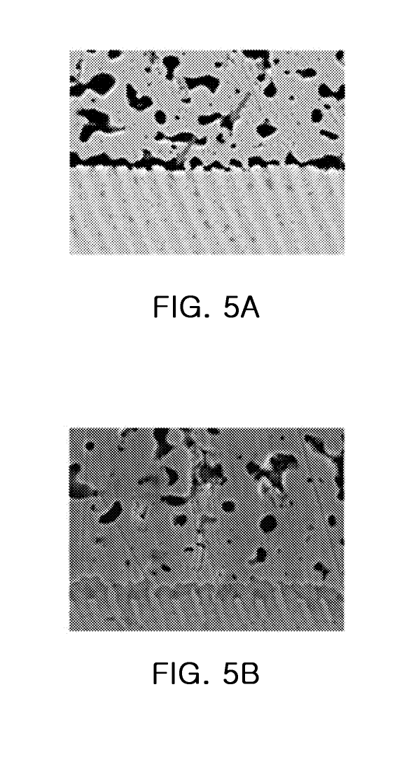

In addition, FIG. 5 is electron micrographs comparing a cross section of an electrode-calcined chip according to an example of the present invention with a cross section of an electrode-calcined chip according to a comparative example, after polishing the cross sections of the chips and submerging the same in a tin (Sn) plating solution for 1 hour.

After introducing each of the glass frits prepared in Comparative Examples 1 through 3 into a Cu paste, the paste was applied to a chip, the chip being subjected to calcination. FIG. 4 showed a microstructure of a termination electrode in the chip as fabricated above.

When the glass frit prepared in Comparative Example 1 was used, through the use of the glass frit, wettability to Cu was improved and glass elution was not observed on a surface of the electrode, therefore a relatively stable micro-structure of the termination electrode could be realized.

However, as described above, the foregoing glass frit had poor corrosion resistance to a plating solution. Thus, when the termination electrode includes a portion having a low degree of electrode coverage, the plating solution may penetrate into this portion.

When either of the glass frits prepared in Comparative Examples 2 and 3 was applied to the chip, through the use of the glass frit, wettability to Cu was deteriorated which in turn causes uneven distribution of the glass frit in a glass sintered electrode. Thus, glass elution was generated on the surface of the termination electrode or the termination electrode had a micro-structure in which the glass frit did not fully fill the interfaces of the termination electrode and the chip ceramic.

When the glass frit prepared in the inventive example was used, glass elution on the surface of the termination electrode was inhibited because of good wettability to Cu thereof, whereby a microstructure of the termination electrode substantially similar to that obtained by Comparative Example 1 could be attained.

As shown in FIG. 5, the glass frit prepared in Comparative Example 1 was thoroughly eroded and removed when a chip having this glass frit applied thereto was submerged in the Sn plating solution (as shown in 5A), whereas the glass frit prepared in the present inventive example still remained without erosion thereof (as shown in 5B).

From the forgoing, it can be seen that the glass frit according to the inventive example of the present invention may inhibit the penetration of a plating solution even when a termination electrode is thin and a degree of electrode coverage is reduced, thereby contributing to an improvement in chip reliability.

As set forth above, according to the exemplary embodiments of the present invention, the conductive paste for a termination electrode contains the glass frit composition having improved corrosion resistance to the tin (Sn) plating solution. Thus, even when the coating thickness of the termination electrode in the multilayer ceramic capacitor is thin, the penetration of the plating solution could be prevented, whereby the chip reliability could be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A conductive paste composition for a termination electrode, comprising:
a conductive metal powder; and
a glass frit represented by the following Formula: aSiO₂-bB₂O₃-cAl₂O₃-dTMₓO_{y}-eR¹₂O-fR²O, where TM is a transition metal selected from a group consisting of zinc (Zn), titanium (Ti), copper (Cu), vanadium (V), manganese (Mn), iron (Fe) and nickel (Ni); R¹ is selected from a group consisting of lithium (Li), sodium (Na) and potassium (K); R² is selected from a group consisting of magnesium (Mg), calcium (Ca), strontium (Sr) and barium (Ba); each of x and y is larger than 0; and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %, provided that these factors are selected respectively in such a manner that a+b+c+d+e+f=100 mole percent (mol %).

2. The conductive paste composition of claim 1, wherein the conductive metal powder is Cu.

3. The conductive paste composition of claim 1, wherein the glass frit has an average particle size ranging from 3.0 to 4.0 μm.

4. The conductive paste composition of claim 1, wherein a content of the glass frit ranges from 5 to 20 parts by weight (wt %) relative to 100 wt % of the conductive metal powder.

5. A method of manufacturing a conductive paste composition for a termination electrode, the method comprising:
weighing each of a silicon oxide, a boron oxide, an aluminum oxide, a transition metal oxide, an alkali-metal oxide and an alkali-earth metal oxide and melting these oxides;
cooling the molten solution to prepare glass flakes;
milling the glass flakes to form a glass frit; and
mixing the glass frit with a conductive metal powder to prepare a paste.

6. The method of claim 5, wherein the transition metal is at least one selected from a group consisting of Zn, Ti, Cu, V, Mn, Fe and Ni.

7. The method of claim 5, wherein the alkali metal is at least one selected from a group consisting of Li, Na and K.

8. The method of claim 5, wherein the alkali-earth metal is at least one selected from a group consisting of Mg, Ca, Sr and Ba.

9. The method of claim 5, wherein the melting is carried out at 1400° C. by heating the oxides at a heating rate of 10° C./min.

10. The method of claim 5, wherein the milling is wet milling using alcohol.

11. The method of claim 5, wherein the conductive metal powder is Cu.

12. The method of claim 5, wherein the glass frit has an average particle size ranging from 3.0 to 4.0 μm.

13. The method of claim 5, wherein a content of the glass frit ranges from 5 to 20 wt % relative to 100 wt % of the conductive metal powder.

14. A multilayer ceramic capacitor, comprising:
a ceramic body;
internal electrode layers provided in the ceramic body, one ends of which are alternately exposed to end surfaces of the ceramic body; and
termination electrodes formed on the end surfaces of the ceramic body and electrically connected to the internal electrode layers,
wherein the termination electrodes are fabricated by calcination of a conductive paste composition which includes a conductive metal powder and a glass frit represented by the following Formula: aSiO₂-bB₂O₃-cAl₂O₃-dTMₓO_{y}-eR¹₂O-fR²O, where TM is a transition metal selected from a group consisting of Zn, Ti, Cu, V, Mn, Fe and Ni, R¹ is selected from a group consisting of Li, Na and K, R² is selected from a group consisting of Mg, Ca, Sr and Ba, each of x and y is larger than 0, and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %, provided that these factors are selected respectively in such a manner that a+b+c+d+e+f=100 mol %.

15. A method of manufacturing a multilayer ceramic capacitor, the method comprising:
preparing a plurality of ceramic green sheets;
forming internal electrode patterns on the ceramic green sheets;
stacking the ceramic green sheets having the internal electrode patterns formed thereon, in order to form a ceramic laminate;
cutting the ceramic laminate to allow one ends of the internal electrode patterns to be alternately exposed through the cut sides of the ceramic laminate, and then, calcining the cut ceramic laminate to produce a ceramic body;
forming termination electrode patterns by using a conductive paste composition for a termination electrode, on end surfaces of the ceramic body in such a manner that the termination electrode patterns are electrically connected to the one ends of the internal electrode patterns, the conductive paste composition comprising a conductive metal powder and a glass frit represented by the following Formula: aSiO₂-bB₂O₃-cAl₂O₃-dTMₓO_{y}-eR¹₂O-fR²O, where TM is a transition metal selected from a group consisting of Zn, Ti, Cu, V, Mn, Fe and Ni, R¹ is selected from a group consisting of Li, Na and K, R² is selected from a group consisting of Mg, Ca, Sr and Ba, each of x and y is larger than 0, and ‘a’ ranges from 15 to 70 mol %, ‘b’ ranges from 15 to 45 mol %, ‘c’ ranges from 1 to 10 mol %, ‘d’ ranges from 1 to 50 mol %, ‘e’ ranges from 2 to 30 mol % and ‘f’ ranges from 5 to 40 mol %, provided that these factors are selected respectively in such a manner that a+b+c+d+e+f=100 mol %; and
sintering the termination electrode patterns to form termination electrodes.

16. The method of claim 15, wherein the conductive metal powder is Cu.

17. The method of claim 15, wherein the glass frit has an average particle size ranging from 3.0 to 4.0 μm.

18. The method of claim 15, wherein a content of the glass frit ranges from 5 to 20 wt % relative to 100 wt % of the conductive metal powder.
